(19) United States
(12) Patent Application Publication
(10) Pub. No.: US 2011/0114420 A1
(43) Pub. Date: May 19, 2011

(54) MULTIPLE HEIGHT LOCKING LIFT ADAPTER FOR A VEHICLE LIFT

(75) Inventor: Gary Henthorn, Camarillo, CA (US)

(73) Assignee: Dannmar Worldwide, Inc., Moorpark, CA (US)

(21) Appl. No.: 12/619,940

(22) Filed: Nov. 17, 2009

(51) Int. Cl. B66F 7/28

(52) U.S. Cl. 187/219

(57) ABSTRACT

A multiple-piece telescoping lift adapter may be locked into any one of plural lengths, by translation and rotation of the different pieces, the end pieces being locked into extended positions relative an intermediate piece by rotations in opposing directions.

### BACKGROUND

A conventional automotive or vehicle lift is employed for elevating a vehicle in a repair garage or facility, and may be a two-post lift, a four-post lift, a portable jack or similar device having a vehicle lift platform. As one example, a two-post vehicle or automotive lift includes a pair of vertical posts and a horizontal lift platform supported on the vertical posts. A hydraulic or pneumatic system enables the user to elevate or lower the lift platform along the vertical posts. The lift platform may support four adjustable horizontal arms each arm having a hollow vertical receptacle for receiving base insert pins of individual height adapters having lift pads at their top ends. Depending upon the height of the vehicle undercarriage from the ground, the user will select four adapters of a height that enables the lift pads to meet the vehicle undercarriage after a minimal elevation of the lift platform from ground level. For this purpose, the user typically stores three sets of four adapters, each set being of a particular height, enabling the user to accommodate a wide range of vehicle sizes or vehicle body heights. Each adapter is of a simple solid cylindrical shape in order to provide a strong reliable support for a large vehicle weight.

Storing such a large number of adapters is problematic, in that the user is constantly exchanging one set of four adapters for another set of four adapters to service different vehicles. For a particular adapter set that is removed from the lift arms, the user carefully stores that set without mixing them with adapters of other sets. Otherwise, the user sorts through his entire collection of adapters (e.g., twelve adapters in the present example) to find a set of four of the desired length.

### SUMMARY

A configurable lift adapter comprises: a cylindrical lifting tube having a hollow interior and an annular wall and defining a tube top and a tube bottom; a first pair of opposing L-shaped slots formed in the annular wall having axial slot portions and transverse slot portions near the tube top extending in a first circumferential direction; a second pair of opposing L-shaped slots formed in the annular wall and having axial slot portions and transverse slot portions near the tube bottom extending in a second circumferential direction; an outer cylindrical sleeve, the tube bottom partially inserted within the outer cylindrical sleeve, and outer sleeve pin ends extending inwardly from an interior surface of the outer cylindrical sleeve and engaged within respective ones of the second pair of opposing slots; and an inner cylinder having a bottom end partially inserted inside the hollow interior at the tube top, and inner cylinder pin ends extending radially outwardly from the inner cylinder and engaged within respective ones of the first pair of opposing slots.

### BRIEF DESCRIPTION OF THE DRAWINGS

So that the manner in which the exemplary embodiments of the present invention are attained and can be understood in detail, a more particular description of the invention, briefly summarized above, may be had by reference to the embodiments thereof which are illustrated in the appended drawings. It is to be appreciated that certain well known processes are not discussed herein in order to not obscure the invention.

FIGS. 1 and 2 are side and top views, respectively, of a two-post vehicle lift employing the configurable adapter.

FIG. 3 is an exploded perspective view of the configurable adapter.

FIG. 4A is an enlarged perspective view of a lifting tube of the configurable adapter of FIG. 3.

FIG. 4B is a flattened image of the lifting tube of FIG. 4A.

FIG. 5 is a perspective view of the assembled configurable adapter of FIG. 3.

FIGS. 6A, 6B and 6C are cut-away side views depicting the configurable adapter installed in an apparatus such as the two-post lift of FIG. 1, in each of three possible heights, h1, h2 and h3, respectively.

To facilitate understanding, identical reference numerals have been used, where possible, to designate identical elements that are common to the figures. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

### DETAILED DESCRIPTION

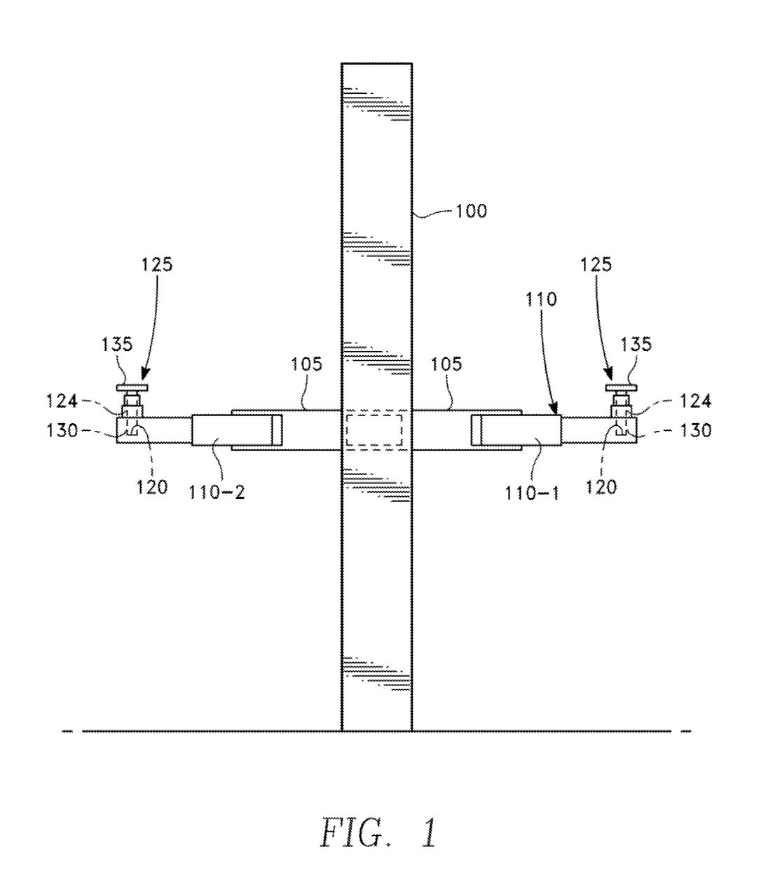

FIG. 1 is a side view of a conventional two-post lift for elevating a vehicle in a repair garage or facility. The two-post lift includes a pair of vertical posts 100 (of which only one is visible in the side view of FIG. 1) and a horizontal lift platform 105 supported on the vertical posts 100. A hydraulic or pneumatic system (not shown) enables the user to elevate or lower the lift platform 105 along the vertical posts 100. As depicted in the top view of FIG. 2, the lift platform 105 may support four adjustable horizontal arms 110 (labeled 110-1 through 110-4). Each arm 110 has a hollow vertical receptacle 120. Four identical height adapters 124 (depicted in dashed line) have their base insert cylinders 130 removably held in the respective receptacles 120. Optionally, each adapter 124 may have a lift pad 135 to engage the vehicle undercarriage or frame. Depending upon the height of the vehicle undercarriage from the ground, the user will select the four adapters 124 of a height that enables the lift pads 135 to meet the vehicle undercarriage after a minimal elevation of the lift platform 105 from ground level. For example, for off-road vehicles suspended high above ground, a set of adapters 124 of a relatively long length would be chosen by the user. The user typically stores three sets of four adapters 124, each set being of a particular height, enabling the user to accommodate a wide range of vehicle sizes or vehicle body heights.

Each adapter 124 is of a simple solid cylindrical shape in order to provide a strong reliable support for a large vehicle weight.

Storing such a large number of adapters is problematic, in that the user is constantly exchanging one set of four adapters 124 for another set of four adapters to service different vehicles. For a particular adapter set that is removed from the lift arms 110, the user carefully stores that set without mixing them with adapters of other sets. Otherwise, the user would sort through his entire collection of adapters (e.g., twelve adapters in the present example) to find a set of four of the desired length.

This problem is solved by providing configurable adapters 125 (shown in solid line in FIG. 1), each configurable adapter 125 being a multiple height configurable (adjustable) adapter that can be quickly locked into any one of several (e.g., three) predetermined lengths. Each configurable adapter 125 may be reliably and quickly locked into any one of the predetermined lengths. At each one of the predetermined lengths into which the configurable adapter is locked, the adapter supports thousands of pounds in axial (vertical) load safely and reliably, through a combination of features that will now be described.

While the foregoing examples refer to the use of configurable adapters 125 on a lift platform 105 of a two post lift, the lift platform may instead be the lift surface of a hydraulic or portable jack or any other vehicle lifting platform, such as a four post lift for example. For this purpose, the lift surface of the portable jack or other lift surface may be provided (optionally) with the adapter receptacles 130 depicted in FIG. 1.

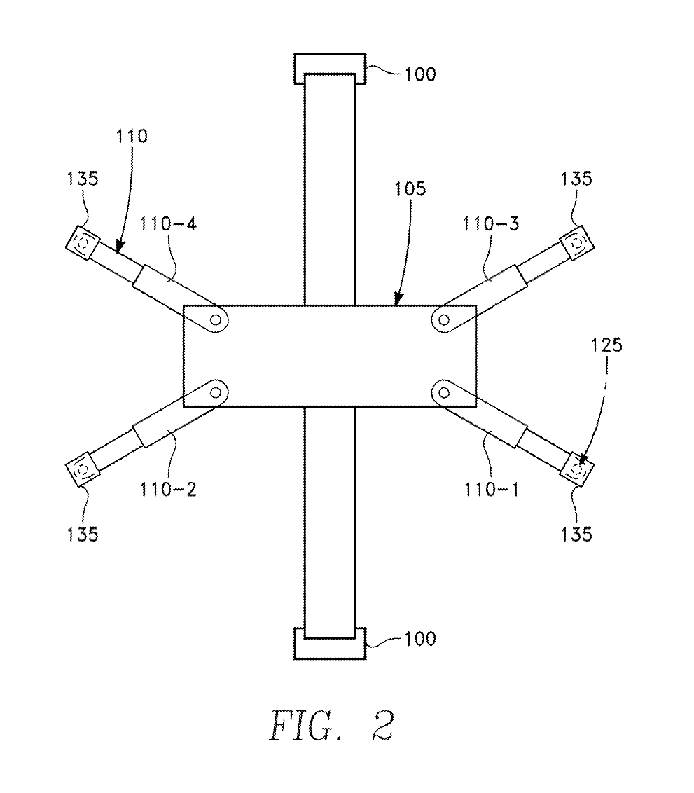

Referring again to FIGS. 1 and 2, each configurable adapter 125 has its base insert cylinder 130 held in the cylindrical receptacle 120 of a respective arm 110. Referring to FIG. 3, the base insert cylinder 130 supports an outer cylindrical sleeve 140 having a hollow interior. The outer sleeve 140 has a pair of outer sleeve pin holes 150-1, 150-2 in mutual alignment along a radial direction. In the illustrated embodiment, the outer sleeve pin holes 150-1, 150-2 are aligned with the cylindrical axis of symmetry of the outer cylindrical sleeve 140. A lifting tube 160 is coaxially received inside the hollow outer sleeve 140. The lifting tube 160 and the outer sleeve 140 are rotatable relative to one another about their common cylindrical axis and mutually translatable along the same axis. The lifting tube 160 is formed with two pairs of opposing axial slots 170 whose function will be described later in this specification. An internal cylinder 180 is coaxially received within the hollow lifting tube 160. The lifting tube 160 and the internal cylinder 180 are rotatable relative to one another about their common cylindrical axis and mutually translatable along the same axis. The lift pad 135 is supported on one end of the internal cylinder 180 protruding from the lifting tube 160. An inner pin hole 190 extends radially through the internal cylinder 180 at one end that is immersed within the lifting tube 160. In the illustrated embodiment, the inner pin hole 190 is centered relative to the cylindrical axis of the internal cylinder 180.

An internal cylinder pin 200 is held (e.g., press-fitted or bonded or welded) within the radial inner pin hole 190 and protrudes radially outwardly at both ends from the outer cylindrical surface of the internal cylinder 180 at opposing sides thereof. As will be described below, the protruding ends of the internal cylinder pin 200 are held within a respective pair of the travel slots 170 of the lifting tube 160. A pair of outer sleeve pins 210 are held (e.g., press-fitted or bonded or welded) within respective ones of the pin holes 150-1, 150-2 of the outer sleeve 140. The outer sleeve pins 210 protrude radially inwardly from the internal surface of the hollow outer sleeve 140. As will be described below, the protruding ends of the outer sleeve pins 210 are held within another respective pair of the travel slots 170 of the lifting tube 160.

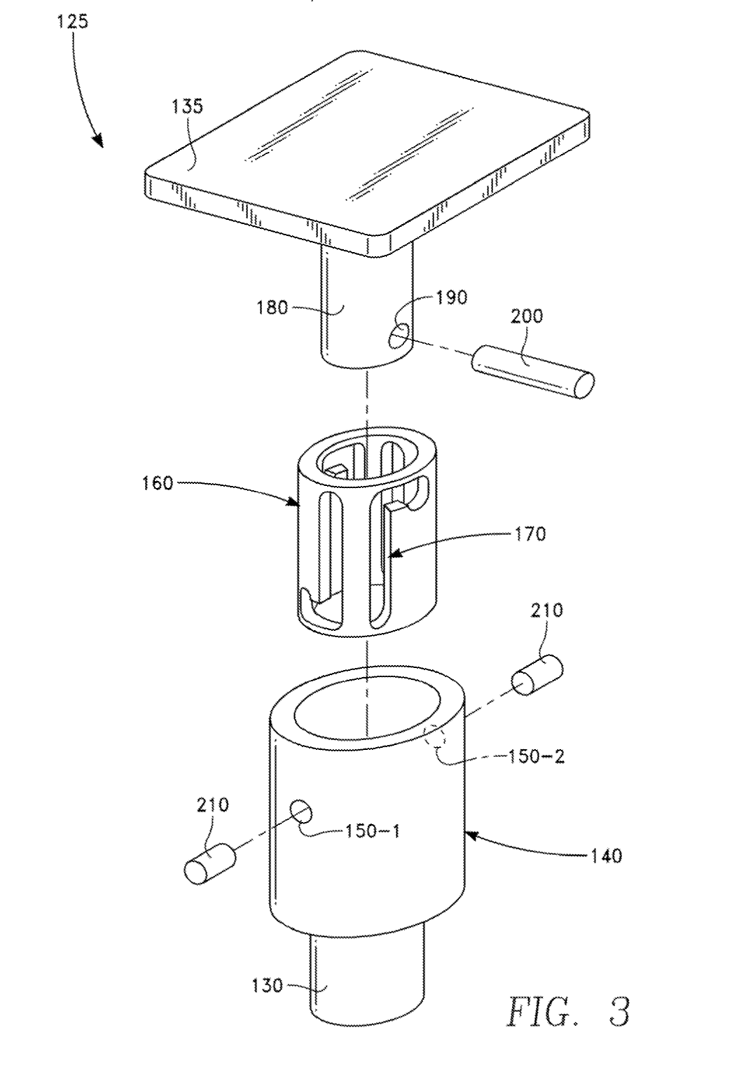

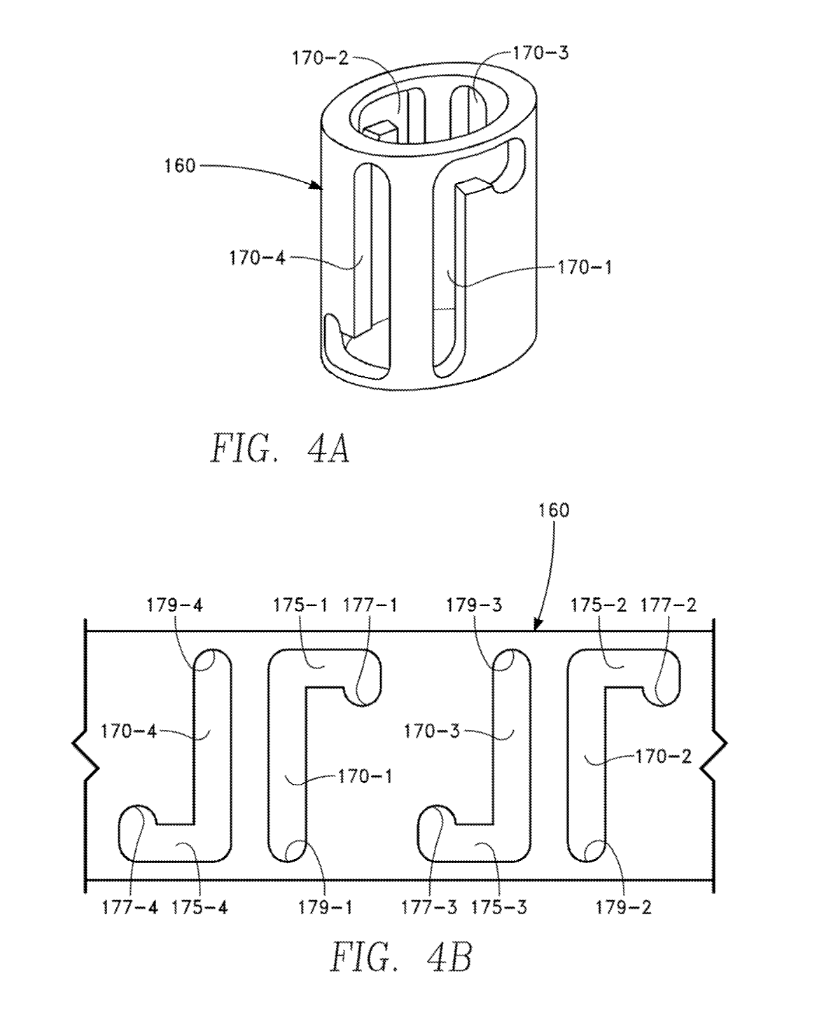

FIG. 4A is an enlarged view of the lifting tube 160 and FIG. 4B is a “flattened” view of the lifting tube 160. Referring to FIGS. 4A and 4B, a first pair of the travel slots 170, specifically the travel slots 170-1 and 170-2, engage the respective protruding ends of the internal cylinder pin 200. In the illustrated embodiment, the travel slots 170-1, 170-2 are located on the cylindrical lifting tube 160 at respective locations offset by about 180 degrees of rotation about the cylindrical axis of symmetry. The ends axial slots 170-1, 170-2 nearest the internal cylinder 180 join respective circumferential slots 175-1, 175-2 extending left-to-right in the view of FIG. 4B. Each circumferential slot 175-1, 175-2 terminates at a respective half-round locking detent 177-1, 177-2 of a radius generally matching that of the internal cylinder pin 200. In a first unextended position, each protruding end of the internal cylinder pin 200 rests at the bottom 179-1, 179-2 of the respective axial slot 170-1, 170-2. To reach a first extended position, the lifting tube 160 and internal cylinder 180 are axially pulled apart from one another until the respective ends of the internal cylinder pin 200 reach the top of the respective axial slots 170-1, 170-2. Then, the internal cylinder 180 and the lifting tube 160 are rotated relative to one another to force the ends of the internal cylinder pin 200 to travel along the respective circumferential slots 175-1, 175-2 until reaching the respective locking detents 177-1, 177-2. At that point, the internal cylinder 180 and the lifting tube 160 are locked in a position in which they are extended from one another by a distance equal to the length of the axial travel slots 170-1, 170-2.

A second pair of the travel slots 170, specifically the travel slots 170-3 and 170-4, engage the protruding ends of the outer sleeve pins 210. In the illustrated embodiment, the travel slots 170-3, 170-4 are located on the cylindrical lifting tube 160 at respective locations offset by about 180 degrees of rotation about the cylindrical axis of symmetry. The ends of the axial slots 170-3, 170-4 nearest the outer sleeve 140 join respective circumferential slots 175-3, 175-4 extending right-to-left in the view of FIG. 4B (i.e., in a direction opposite to that of the circumferential slots 175-1, 175-2 of the first pair of slots). This opposing (mirror) relationship of the different pairs of slots enables the user to lock the extended position of either the outer sleeve 140 or the internal cylinder 180 relative to the lifting tube 160 without unlocking the other. Each circumferential slot 175-3, 175-4 terminates at a half-round locking detent 177-3, 177-4 of a radius generally matching that of each outer sleeve pin 210. In a first unextended position, the outer sleeve pins 210 rest at the respective tops 179-3, 179-4 of the respective axial slots 170-3, 170-4. To reach a first extended position, the lifting tube 160 and outer sleeve 140 are axially pulled apart from one another until the pins 210 reach the bottom of the respective axial slots 170-3, 170-4. Then, the outer sleeve 140 and the lifting tube 160 are rotated relative to one another to force the pins 210 to travel along the respective circumferential slots 175-3, 175-4 until reaching the respective locking detents 177-3, 177-4. At that point, the outer sleeve 140 and the lifting tube 160 are locked in a position in which they are extended from one another by a distance equal to the length of the axial travel slots 170-3, 170-4.

In the illustrated embodiment, the four axial travel slots 170-1, 170-2, 170-3 and 170-4 are uniformly distributed about the cylindrical axis of symmetry of the cylindrical lifting tube 160 (e.g., at 90 degree intervals), while the axial travel slots of each pair—e.g., the axial travel slots 170-1 and 170-2—are placed at opposite locations (e.g., offset by 180 degrees, as mentioned previously).

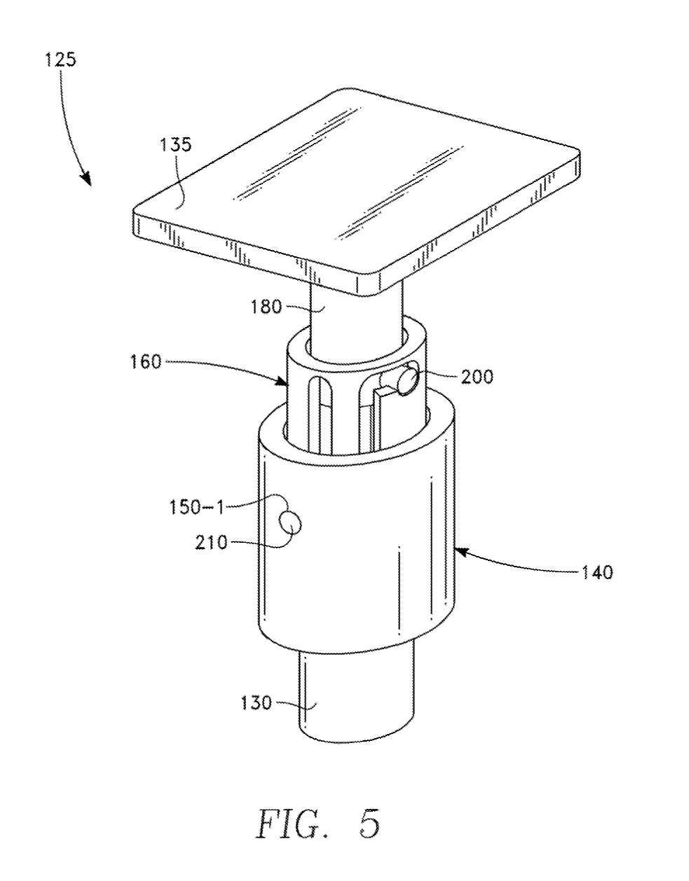

FIG. 5 is a perspective view of the assembly of the lifting tube 160, the internal cylinder 180 and the outer sleeve 140. In this assembly, the pin 200 is inserted through the internal cylinder pin hole 190 while in alignment with the respective travel slots 170-1, 170-2. Furthermore, the outer pins 210 are inserted through the outer sleeve pin holes 150-1, 150-2 while in alignment with the respective travel slots 170-3, 170-4.

Because the first pair of circumferential slots 175-1, 175-2 extend in a direction opposite to the second pair of circumferential slots 175-3, 175-4, the user can easily lock or unlock the position of either one of the internal cylinder 180 or the outer sleeve 140 relative to the lifting tube 160 without unintentionally unlocking the other. This is because the opposing relationship between the two pairs of circumferential slots (i.e., the first pair 175-1, 175-2 and the second pair 175-3, 175-4) enables the user to lock one or both of the internal cylinder 180 and outer sleeve 140 relative to the lifting tube 160 using the same rotational motion between the internal cylinder 180 and the outer sleeve 140. For example, both may be locked simultaneously with the same twisting or rotational motion between the internal cylinder 180 and the outer sleeve 140.

No rotation or locking is required whenever either the outer sleeve 140 or the interior cylinder 180 are set to their fully retracted positions relative to the lifting tube 160.

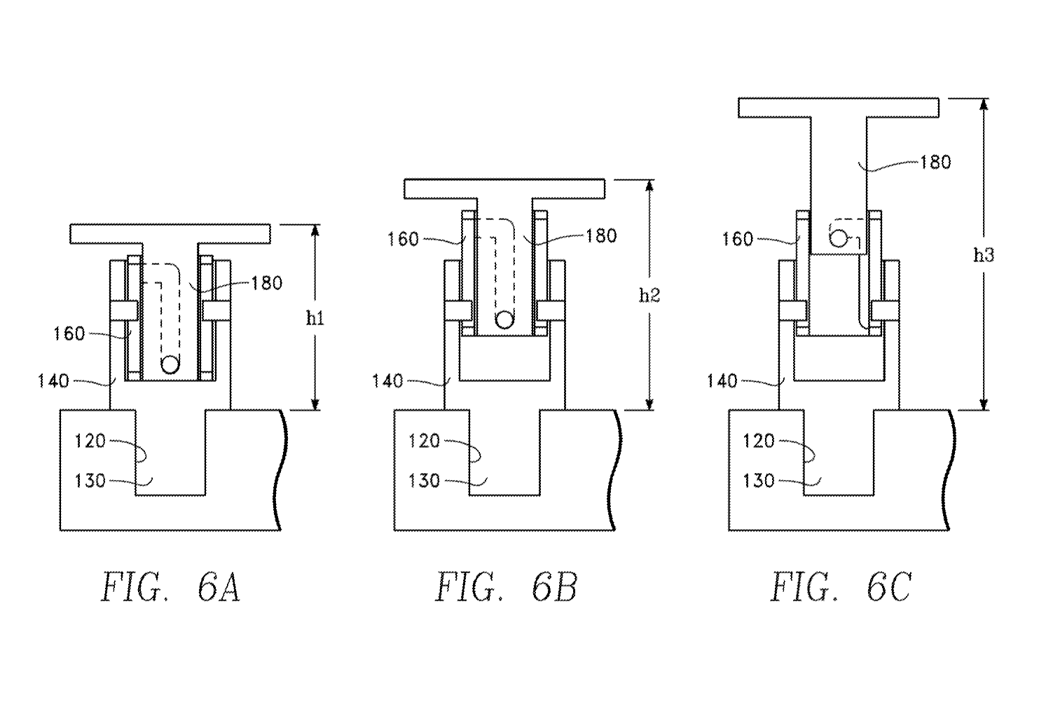

Referring to FIGS. 6A, 6B and 6C, the configurable adapter of FIG. 5 may set to any one of three lengths. As shown in FIG. 6A, at the shortest length, both the interior cylinder 180 and the outer sleeve 140 are in their unextended (retracted) positions relative to the lifting tube 160. As shown in FIG. 6B, at an intermediate length, only the outer sleeve 140 is locked in an extended position. Alternatively, although not depicted in FIG. 6B, the intermediate length is realized by locking only the internal cylinder 180 relative to the lifting tube 160, while the external sleeve 140 remains in its unextended position. As shown in FIG. 6C, the longest length is realized by locking both the internal cylinder 180 and the outer sleeve 140 in their extended positions relative to the lifting tube 160.

The configurable adapter of FIG. 5 is capable of supporting thousands of pounds in vertical load. The wall thickness of the lifting tube 160 and of the outer sleeve 140 is thick, on the order of 6 mm or in a range of 5 mm to 15 mm. The diameter of the outer sleeve pins 210 and of the inner cylinder pin 200 is large, on the order of 9 mm or in a range of 7 mm to 20 mm. The width of each of the slots 170, 175 matches the pin diameter (e.g., 9 mm) and includes an allowance (e.g., 0.1 mm) to permit movement of each pin within its slot. The width of each of the slots 170, 175 matches the pin diameter (e.g., 9 mm) and includes an allowance (e.g., 0.1 mm) to permit movement of each pin within its slot. The three telescoping pieces (i.e., the interior cylinder 180, the lifting tube 160 and the outer sleeve 140) are closely sized. Specifically, the interior diameter of the lifting tube 160 nearly matches the outside diameter of the inner cylinder 180 and includes an allowance (e.g., 0.1 mm) to permit rotation and translation of the lifting tube 160 and inner cylinder 180 relative to one another. Similarly, the interior diameter of the outer sleeve 140 nearly matches the outside diameter of the lifting tube 160 and includes an allowance (e.g., 0.1 mm) to permit rotation and translation of the outer sleeve 140 and the lifting tube 160 relative to one another.

While the foregoing is directed to embodiments of the present invention, other and further embodiments of the invention may be devised without departing from the basic scope thereof, and the scope thereof is determined by the claims that follow.

What is claimed is:

1. A configurable lift adapter, comprising:
a cylindrical lifting tube having a hollow interior and an annular wall and defining a tube top and a tube bottom;
a first pair of opposing L-shaped slots formed in said annular wall having axial slot portions and transverse slot portions near said tube top extending in a first circumferential direction;
a second pair of opposing L-shaped slots formed in said annular wall and having axial slot portions and transverse slot portions near said tube bottom extending in a second circumferential direction;
an outer cylindrical sleeve, said tube bottom partially inserted within said outer cylindrical sleeve, and outer sleeve pin ends extending inwardly from an interior surface of said outer cylindrical sleeve and engaged within respective ones of said second pair of opposing slots; and
an inner cylinder having a bottom end partially inserted inside said hollow interior at said tube top, and inner cylinder pin ends extending radially outwardly from said inner cylinder and engaged within respective ones of said first pair of opposing slots.

2. The configurable lift adapter of claim 1 further comprising:
a vehicle pad surface supported on a top end of said inner cylinder.

3. The configurable lift adapter of claim 1 further comprising:
a base insert pin extending axially from a bottom end of said outer sleeve.

4. The configurable lift adapter of claim 1 wherein said outer sleeve pin ends fixed with respect to said outer sleeve.

5. The configurable lift adapter of claim 1 wherein said inner cylinder pin ends are fixed with respect to said inner cylinder.

6. The configurable lift adapter of claim 1 wherein said first and second circumferential directions are opposite one another.

7. The configurable adapter of claim 1 wherein:
the axial slot portions of said first pair of slots are offset from one another by 180 degrees about a cylindrical axis of symmetry of said cylindrical lifting tube; and
the axial slot portions of said second pair of slots are offset from one another by 180 degrees about a cylindrical axis of symmetry of said cylindrical lifting tube.

8. A configurable lift adapter, comprising:
a cylindrical lifting tube having a hollow interior and an annular wall and defining a tube top and a tube bottom;
a first pair of opposing slots formed in said annular wall, each of said first pair of slots comprising: (a) an axial slot having a first slot end near said tube bottom and a second slot end near said tube top, and (b) a top circumferential slot extending from said second slot end in a first circumferential direction and an arcuate detent at an end of said top circumferential slot;
a second pair of opposing slots formed in said annular wall, each of said second pair of slots comprising: (a) an axial slot having one slot end near said tube top and an other slot end near said tube bottom, and (b) a bottom circumferential slot extending from said other slot end in a second circumferential direction opposite said first circumferential direction, and an arcuate detent at an end of said bottom circumferential slot;
an outer cylindrical sleeve, said tube bottom partially inserted within said outer cylindrical sleeve, and outer sleeve pin ends extending inwardly from an interior surface of said outer cylindrical sleeve and engaged within respective ones of said second pair of opposing slots; and
an inner cylinder having a bottom end partially inserted inside said hollow interior at said tube top, and inner cylinder pin ends extending radially outwardly from said inner cylinder and engaged within respective ones of said first pair of opposing slots.

9. The configurable lift adapter of claim 8 further comprising:
a vehicle pad surface supported on a top end of said inner cylinder.

10. The configurable lift adapter of claim 8 further comprising:
a base insert pin extending axially from a bottom end of said outer sleeve.

11. The configurable lift adapter of claim 8 wherein said outer sleeve pin ends fixed with respect to said outer sleeve.

12. The configurable lift adapter of claim 8 wherein said inner cylinder pin ends are fixed with respect to said inner cylinder.

13. The configurable adapter of claim 8 wherein:
the axial slot portions of said first pair of slots are offset from one another by 180 degrees about a cylindrical axis of symmetry of said cylindrical lifting tube; and
the axial slot portions of said second pair of slots are offset from one another by 180 degrees about a cylindrical axis of symmetry of said cylindrical lifting tube.

14. The configurable adapter of claim 8 wherein the axial slot portions of said first and second pairs of slots are periodically distributed with respect to a cylindrical axis of symmetry of said cylindrical lifting tube.
